(19) United States
(12) Patent Application Publication
(10) Pub. No.: US 2012/0304642 A1
(43) Pub. Date: Dec. 6, 2012

(54) INTERNAL COMBUSTION ENGINE

(76) Inventors: Kay Arnold, Affalterbach (DE); Peter Kalisch, Unterensingen (DE)

(21) Appl. No.: 13/589,142

(22) Filed: Aug. 19, 2012

Related U.S. Application Data
(63) Continuation-in-part of application No. PCT/EP2010/007315, filed on Dec. 2, 2010.

(30) Foreign Application Priority Data
Mar. 2, 2010 (DE) 10 2010 009 913.9

(51) Int. Cl. F02B 37/00; F01M 1/06; F02B 33/00

(52) U.S. Cl. 60/605.3; 60/605.1

(57) ABSTRACT

In an internal combustion engine having at least one exhaust gas turbocharger and an engine crankcase with at least one ventilation unit, by means of which a mixture of gas and lubricant generated in the crankcase of the internal combustion engine can be removed from the engine crankcase, and which cooperates with at least one first separating unit, by means of which lubricant can be separated from the gas and lubricant mixture formed in the crankcase, at least one further separating unit is associated with the at least one exhaust gas turbocharger, by means of which lubricant of a mixture of the lubricant and gas formed in the exhaust gas turbocharger can be separated from the lubricant and gas mixture.

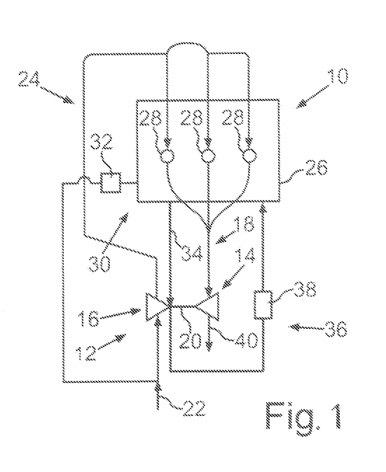

This is a Continuation-In-Part application of pending international patent application PCT/EP2010/007315 filed Dec. 02, 2010 and claiming the priority of German patent application 10 2010 009 913.9 filed Mar. 2, 2010.

### BACKGROUND OF THE INVENTION

The invention relates to an internal combustion engine including an exhaust gas turbocharger and having a crankcase with a ventilation system for removing a mixture of gas and lubricant from the engine and means for separating the lubricant from the gas.

All internal combustion engines used in motor vehicles include such crankcase ventilation systems. The ventilation systems are necessary as a substantially gaseous mixture collects in the crankcase during operation of the internal combustion engine. This mixture consists substantially of combustion gases which flow out of combustion chambers of the internal combustion engine past the pistons into the crankcase and also includes lubricating oil of the internal combustion engine entrained into the gas. In order to avoid a pressure increase in the crankcase this mixture is removed from the crankcase. In order to reduce emissions the ventilation system cooperates with a separating unit, by means of which the lubricating oil is separated from the mixture.

DE 199 29 876 A1 discloses an internal combustion engine with a ventilation unit which serves for the ventilation of the crankcase, cooperates with an oil separator. It is connected to a suction pipe of the internal combustion engine and is also provided with throttles. The ventilation unit is provided for both the ventilation of an engine crankcase and also of at least one turbocharger. The crankcase ventilation and the turbocharger ventilation are connected to a distributor unit associated with an oil separator. The distributor unit comprises a first throttle and a second throttle, wherein the first throttle is preferably connected, with the intermediate positioning of the oil separator, to a first pipe in communication with the suction pipe and the second throttle is connected to a second pipe also in communication with the suction pipe, in such a way that the ventilation unit is effective during engine suction operations via the second pipe and in engine charging operations via the first pipe.

For those known internal combustion engines with such ventilation units however there is further potential for lowering the emissions.

It is thus the principal object of the present invention to further reduce the emissions of a turbocharged internal combustion engine.

### SUMMARY OF THE INVENTION

In an internal combustion engine having at least one exhaust gas turbocharger and an engine crankcase with at least one ventilation unit, by means of which a mixture of gas and lubricant generated in the crankcase of the internal combustion engine can be removed from the engine crankcase, and which cooperates with at least one first separating unit, by means of which lubricant can be separated from the gas and lubricant mixture formed in the crankcase, at least one further separating unit is associated with the at least one exhaust gas turbocharger, by means of which lubricant of a mixture of the lubricant and gas formed in the exhaust gas turbocharger can be separated from the lubricant and gas mixture.

The at least one further separating unit of the internal combustion engine according to the invention thus provides for a separation of additional lubricant from the gas, whereby on the one hand the gas or mixture to be discharged to the environment or to be fed back to the internal combustion engine via the engine intake duct is purified of the lubricant. This reduces the emissions of the internal combustion engine and also reduces the amount of deposits in the exhaust gas turbocharger and charge air cooler. Furthermore with this additional separating unit the first separating unit is unburdened, which makes the use of smaller separating units possible and thus a reduces the cost and also the weight of the units and, most importantly, further reduces the emissions of the internal combustion engine.

If at least one recirculation pipe is provided, by means of which the lubricant of the mixture of the exhaust gas turbocharger can be re-circulated into the crankcase, and if the at least one additional separating unit is arranged in the flow direction of the lubricant to be re-circulated via the re-circulating pipe between the exhaust gas turbocharger and the at least first separating unit, the additional separating unit provides for a pre-purifying of the mixture. Without the presence of the at least one additional separating unit there would be a heavy burden on the first separating unit which would lead to increased emissions of the internal combustion engine. This is at least reduced in the internal combustion engine according to the invention, as the lubricant, which is present in the form of mist caused by the rotation of components of the exhaust gas turbocharger to be lubricated, can be separated from the gas. The gas purified of the lubricant is re-circulated to the crankcase. This pre-purified gas does not then constitute a burden or only a slight burden on the first separating unit, whereby also a reduction of the emissions of the internal combustion engine is achieved.

The at least one additional separating unit is advantageously integrated into the recirculation pipe. This keeps the construction space requirement of the internal combustion engine low and thus contributes to avoidance or easing of package problems. This is particularly advantageous in a space-critical area, such as the engine compartment of a motor vehicle.

In any case a quantity of lubricant to be separated by the first separating means is reduced by the pre-purification according to the invention that is by a corresponding pre-separation by means of the additional separating unit.

According to an advantageous embodiment of the invention the at least one further separating unit is integrated into a housing of the exhaust gas turbocharger, whereby this keeps assembly resources low, as the further separating unit can advantageously be assembled at least virtually simultaneously with the exhaust gas turbocharger. The exhaust gas turbocharger and the separating unit integrated into its housing can thereby be supplied pre-assembled to a corresponding assembly line for an internal combustion engine. This leads to an elimination of engine assembly line procedures, which keeps the assembly time and thus the overall costs for the assembly of the internal combustion engine low.

It can also be provided that the at least one additional separating unit is integrated into the crankcase of the engine or into the recirculation pipe leading to the crankcase, whereby this also reduces the assembly requirements as well as the construction space requirement for the internal combustion engine according to the invention.

In order to separate the lubricant from the gas by way of the at least one additional separating unit, the use of different physical processes is possible. The selection of the physical process used for separating depends on the droplet size of the lubricant present in the form of mist in the mixture in the flow of the mixture upstream of the at least one additional separating unit. If this droplet size is considered in the choice of the physical process for the separation, the at least one additional separating unit can be made dependent on prevailing secondary conditions of the exhaust gas turbocharger and optimized therefor.

The mixture of lubricant and gas which is produced in the exhaust gas turbocharger and from which the lubricant is to be separated by the at least one additional separating unit generally comprises a higher proportion of lubricant than the mixture which is generated in the crankcase as a result of the swirling of the lubricant by the components rotating in the crankcase. The physical process used in the at least one further separating unit can thereby differ advantageously from the physical process used in the first separating unit. As already indicated, the respective separating unit is chosen based on existing secondary conditions of the exhaust gas turbocharger or the crankcase in order to realize a maximum separation of the respective lubricant from the respective gas.

In summary it can be stated that an arrangement of the at least one additional separating unit in an air recirculation of the exhaust gas turbocharger and the associated pre-separation of the mist-like lubricant from the circulated air, which is formed for example from the lubricating oil of the internal combustion engine, clearly reduces the load of the first separating unit of the internal combustion engine. This means a significant improvement in the overall quantity of mist-like lubricant to be separated by the first separating unit. This results in particularly low emissions of the internal combustion engine and keeps the exhaust gas turbocharger and charge air cleaner, as for example the air volume drawn in by the internal combustion engine due to a recirculation of the crankcase air to a suction side of the internal combustion engine for combustion in the engine is clearly reduced, This results in a clear improvement in exhaust gas values of the internal combustion engine.

The invention will become more readily apparent from the following description of a preferred embodiment thereof with reference to the accompanying drawing.

### BRIEF DESCRIPTION OF THE DRAWING

The sole drawing is a schematic view of an internal combustion engine with a crankcase and an exhaust gas turbocharger, wherein two separating units are provided for removing lubricant from a mixture of the lubricant and gas.

### DETAILED DESCRIPTION OF A PREFERRED EMBODIMENT

The figure shows an internal combustion engine 10 with an exhaust gas turbocharger 12 which comprises a turbine 14 and a compressor 16. The turbine 14 is driven in the known manner by exhaust gas of the internal combustion engine 10 which is fed via corresponding pipes 18 to the turbine 14 and drives a turbine wheel of the exhaust gas turbocharger 12. The turbine wheel is fixed rotationally securely to a shaft 20 of the exhaust gas turbocharger 12, wherein the shaft 20 is in turn rotationally securely connected to a compressor wheel of the compressor 16 and therefore the compressor wheel is driven via the shaft 20 by the turbine wheel. The compressor wheel of the compressor 16 compresses intake air and supplies it to the internal combustion engine 10 according to a direction arrow 22, the air being fed via corresponding pipes 24 to the internal combustion engine 10 for combustion therein in order to generate a certain torque and a certain power output.

The internal combustion engine 10 comprises an engine housing 26, in which lubricating oil is received for lubricating rotating components of the internal combustion engine 10. An air/oil mixture is formed in the crankcase 26 during the operation of the internal combustion engine 10. The mixture is formed substantially by lubricating oil swirled up by the rotating components and thus forms a mist with gas which has escaped from cylinders 28 of the internal combustion engine 10 into the engine crankcase 26.

In order to avoid an excessive pressure increase in the engine crankcase 26 this mixture must be removed from the engine crankcase 26. A discharge of this mixture to the environment without purification would lead to high emissions and to a high environmental burden. In order to avoid this problem the internal combustion engine 10 is provided with a ventilation unit 30, by way of which the mixture of gas and lubricating oil can be removed from the engine crankcase 26. The ventilation unit 30 thereby cooperates with a first separating unit 32, by means of which the lubricating oil can be separated from the gas. There is thus no lubricating oil or only a very small quantity of lubricating oil in the gas and the gas can be re-circulated to a suction side of the internal combustion engine 10 and fed via the pipes 24 back to the cylinders 28 for combustion. This keeps the emissions of the internal combustion engine 10 low.

The exhaust gas turbocharger 12 also requires lubricating oil of the internal combustion engine 10 to lubricate its rotating components, for example to lubricate the shaft 20 or corresponding bearing points. For this a first pipe 34 is provided, by way of which lubricating oil is fed to the exhaust gas turbocharger 12. The rotation of the shaft 20 also leads to swirling of the lubricating oil, whereby a mixture is also produced in the exhaust gas turbocharger 12. This mixture consists of the lubricating oil of the exhaust gas turbocharger 12 or the internal combustion engine 10 and a gas which flows both from the turbine 14 and from the compressor 16 to the components to be lubricated, in particular the shaft 20, and mixes with the lubricating oil.

In order to close the circuit a recirculation pipe 36 is provided, by means of which the lubricating oil or the mixture removed from the turbocharger is re-circulated back to the crankcase 26.

For further reduction of the emissions of the internal combustion engine 10 and in order to unburden the first separating unit 32 an additional separating unit 38 is provided which communicates fluidically with the recirculation pipe 36 and by means of which the lubricating oil of the mixture of the lubricating oil and the gas of the exhaust gas turbocharger 12 can be separated. This leads to a clear reduction of the total amount of lubricating oil to be separated by the separating unit 32, whereby the emissions of the internal combustion engine are reduced to a very low level. The gaseous and the liquid portion flow in the recirculation pipe 36 from the separating unit 38 back to the engine housing 26 either in one pipe though separately or in two separate pipes (not shown).

As is apparent from the drawing, this means that the air drawn in by the internal combustion engine 10 no longer includes any, or includes only extremely small quantities of, lubricating oil which is finally combusted in the cylinder 28 and which was initially fed the turbocharger 12 for lubrication. According to a direction arrow 40, only relatively clean exhaust gas is therefore supplied to at least one exhaust gas treatment unit and subsequently discharged to the environment. This avoidance or at least significant reduction of oil returned with the drawn-in air to the engine to be combusted therein results in extremely low exhaust gas emission values of the internal combustion engine 10, whereby all current and also future emission limits can be observed.

What is claimed is:

1. An internal combustion engine (10) having at least one exhaust gas turbo-charger (12) and a crankcase (26) with at least one ventilation unit (30), by way of which a mixture of gas and lubricant generated in the crankcase (26) of the internal combustion engine (10) can be removed from the engine crankcase (26), and which cooperates with at least a first separating unit (32) for the separation of lubricant from the gas and lubricant mixture, and
at least one additional separating unit (38) associated with the at least one exhaust gas turbocharger (12), by means of which lubricant of a mixture of the lubricant and gas formed in the exhaust gas turbocharger (12) can be separated from the lubricant and gas mixture generated in the exhaust gas turbocharger (12).

2. The internal combustion engine (10) according to claim 1, wherein a recirculation arrangement (36) extends from the exhaust gas turbocharger (12) to the crankcase (26), by means of which the lubricant of the exhaust gas turbocharger (12) can be re-circulated into the engine crankcase (26).

3. The internal combustion engine (10) according to claim 2, wherein the at least one additional separating unit (38) is included in the recirculation arrangement (36) between the exhaust gas turbocharger (12) and the crankcase (26).

4. The internal combustion engine (10) according to claim 3, wherein the at least one additional separating unit (38) is integrated into the recirculation arrangement (36).

5. The internal combustion engine (10) according to claim 3, wherein the at least one additional separating unit (38) is integrated into a housing of the exhaust gas turbocharger (12).

6. The internal combustion engine (10) according to claim 3, wherein the at least one additional separating unit (38) is integrated into the crankcase (26).
